(19) United States
(12) Patent Application Publication
(10) Pub. No.: US 2006/0198986 A1
(43) Pub. Date: Sep. 7, 2006

(54) Multilayer packaging with peelable coupon

(76) Inventors: Michael S. Keckeisen, Neenah, WI (US); Stephanie L. Emenecker, Neenah, WI (US)

Correspondence Address: BEMIS COMPANY, INC., 2200 BADGER AVENUE, OSHKOSH, WI, 54904, US

(21) Appl. No.: 11/069,124

(22) Filed: Mar. 1, 2005

(51) Int. Cl. B32B 3/10; B32B 37/00

(52) U.S. Cl. 428/136; 156/277; 156/253

(57) ABSTRACT

A multilayer film with an inegrated peelable coupon that can be used with promotional packaging for products. The flexible multilayer film has at least a first polymeric layer, indicia, a layer of release coating that is applied in a pattern to an inner surface of the first layer, and a second polymeric layer, which may be made in combination with additional layers. A removable portion of the film structure is provided by a pattern of perforations or slits through the outer layers of film in alignment with the release coating pattern. The method manufacturing the multilayer film with an integrated coupon includes providing a first layer as an outer layer, printing indicia, applying a layer of release coating in a pattern to a portion of an inner surface of the first thermoplastic layer, cutting slits lines through certain layers, and laminating a second polymeric layer.

### BACKGROUND

The present disclosure relates to a film with an integrated peelable coupon. More particularly, the disclosure relates to a multilayer film having at least a first layer, indicia printed on the first layer, a layer of release coating applied in a pattern to the indicia on the inner surface of the first layer, and another polymeric layer resulting in a peelable portion of the film structure from a pattern of perforations or slits through certain layers of film.

Packaging is becoming more sophisticated to keep up with promotional requests from the marketer of products. Cost-effective promotions can generate excitement for a product and increase sales. Packaging for products should be consumer friendly and easy to use. One pertinent area includes coupons that can be peeled from packaging film to reveal a store coupon or sweepstakes prize.

Store coupons or games pieces have been inserted inside a bag with the promotion advertised on the outside of the package. This technique readily allows for different store coupons or unique game pieces to be inserted, but the insertion complicates processing and often pieces are not inserted in every package. Next, store coupons or games pieces have been adhered to the outside of packages like labels. This technique has the shortcoming that store coupons or game pieces can be removed by “non-customers” who remove the label without purchasing the product. Store coupons or game pieces have been incorporated into packaging as promotions to avoid these concerns and to encourage purchase of the product.

Multilayer films can be used to produce bags for packaging food or other items. Different layers have distinct properties, and continuous layers, such as metallized polypropylene, are known to have barrier properties. The layers of film can be adhesive or extrusion laminated.

Extrusion lamination involves using a thin polymeric layer, typically polyethylene, to bond to other layers of film or foil. Extrusion lamination has certain benefits over adhesive lamination in producing multilayer flexible packaging, such as building a thicker and stronger multilayer lamination. Also, preferable to adhering separate layers together, extrudates have cost advantages and fewer environmental issues over adhesives. It can be preferable to avoid adhesives in making film.

A possible structure for packaging for salty snacks is an outer layer of clear oriented polypropylene, ink or indicia reverse printed, an extrudate of polyethylene, and a metallized oriented polypropylene. The inner metallized polypropylene layer provides barrier properties.

U.S. Pat. No. 6,746,743 discloses a flexible container with a wall structure comprised of multi-layer, flexible thin films, including a first film layer that is affixed to the wall structure by a releasable adherence and that incorporates a removable promotional piece. The multi-layer thin film incorporates a promotional piece, defined by a continuous cut, into the outermost layer of the container. Removal of the removable portion of the multi-layer film does not compromise the barrier properties of the container.

U.S. Pat. No. 6,041,929 discloses a flexible film laminate including an outer layer, an inner layer, and an adhesive layer for attaching those two layers. The adhesive layer includes a non-adhesive portion where the outer layer is not adhered to the inner layer where the hidden printed indicia portion contacts the inner layer. An ink layer can be printed on the inside surface of the outer layer. A gray block layer obscures an ink pattern on the inside surface of the outer layer. Another ink layer is disposed on the gray block layer. When the outer layer is cut or punctured to access the promotional device, this permits the portion of the outer layer containing the device to be separated from the inner layer and viewed directly.

U.S. Pat. No. 5,127,743 discloses a method of forming a package comprised of multi-layer flexible films wherein a promotional device is printed on the inside surface of one of the outer layers of the package. The promotional printed indicium is only partially visible from the outside of the package and is accessed by puncturing the outer layer of the package and separating the inner layer from the outer layer containing the hidden indicia. This separation is possible because no adhesive is applied between the portion of the outer layer containing the printed hidden indicia and the next innermost layer of the container.

Thus, it is desirable to produce multilayer film with a peelable coupon that is easy to make and easy to use. Incorporating the coupon into the outer layer of the film lowers material and processing costs compared with designs employing a promotional piece that is inside the packaging or between layers of film.

### SUMMARY

The present invention is a multilayer film with an integrated peelable coupon that can be used with promotional packaging for products. The flexible multilayer film has at least a first layer, indicia, a layer of release coating that is applied in a pattern to an inner surface of the first layer (or its indicia), and a second polymeric layer, which may be made in combination with additional layers. A removable portion of the film structure is provided by a pattern of perforations or slits (including score lines) through certain layers of the film in alignment with the release coating pattern. In a preferred embodiment, the film can form a web with repeating patterns, so different indicia can be printed on each portion of the inner surface that corresponds to each row of peelable coupons.

A method manufacturing a multilayer film with an integrated coupon includes providing a first polymeric layer as an outer layer, printing indicia, applying a layer of release coating in a pattern to a portion of an inner surface of the first polymeric layer, cutting slits lines through certain layers, and extrusion laminating a second polymeric layer. In a preferred embodiment, two parallel slit lines are cut an entire length of the film so the second polymeric layer has a removable banner strip defined by slit lines through the outer layer, the indicia, and into the layer of release coating. Also, the second layer or an additional inner layer that have a different appearance from an outer surface of the outer layer can be part of the multilayer film.

### BRIEF DESCRIPTION OF THE DRAWINGS

The features of this disclosure and the manner of obtaining them will become more apparent, and the disclosure itself will be best understood by reference to the following description of embodiments of the film taken in conjunction with the accompanying drawings showing particular embodiments of the film, wherein:

FIG. 1 shows a cross sectional view of an embodiment of a film;

FIG. 2 shows a planar view of a film;

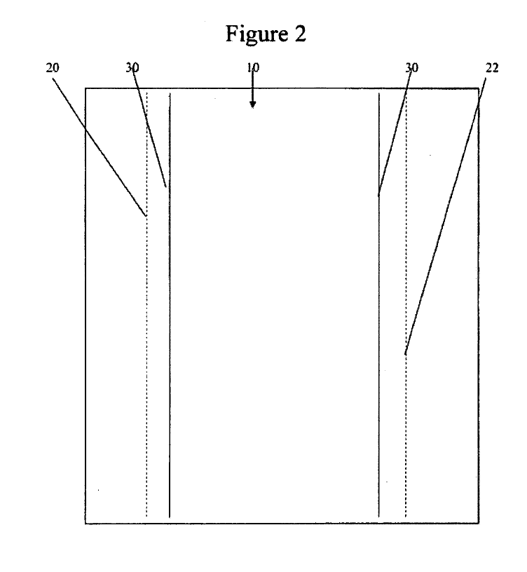

FIG. 3 shows a web with three sections;

FIG. 4 shows a roll of film with a removable banner;

FIG. 5 shows a cross sectional view of an embodiment of a film having a printed code;

FIG. 6 shows a perspective view of a banner being peeled from a bag.

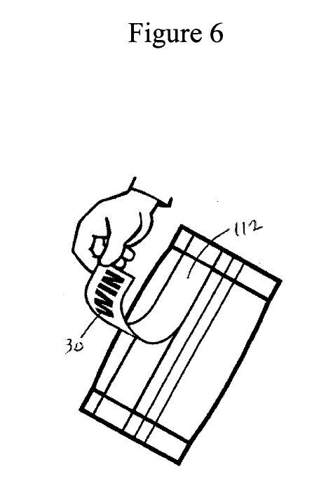

### DETAILED DESCRIPTION

While the present invention will be fully described hereinafter with reference to the accompanying drawings, in which particular embodiments are shown, it is to be understood at the outset that persons skilled in the art may modify the embodiments disclosed herein while still achieving the desired result. Accordingly, the description that follows is to be understood as a broad informative disclosure directed to persons skilled in the appropriate art and not as limitations of the present disclosure.

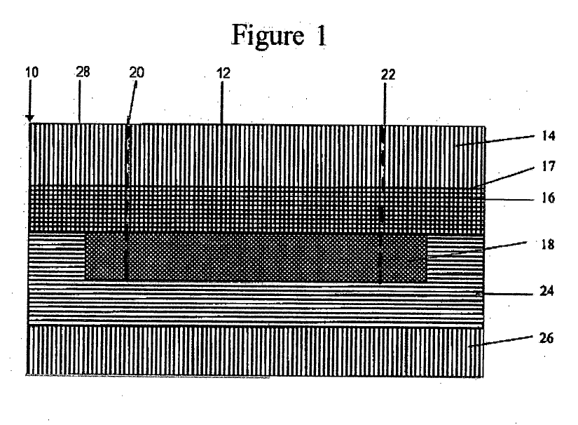

FIG. 1 shows a multilayer film 10 with a peelable coupon 12, which is broadly defined as any removable or peelable section. The peelable coupon 12 is adhesive-free so it is not tacky when removed. The multilayer film 10 has an outer layer 14, preferably thermoplastic, such as an oriented polypropylene or other suitable film. The “outer layer” does not necessarily mean the outermost layer of the film 10. Indicia 16, such as words, logos, patterns and trademarks, can be coated on an inner surface 17 of the outer layer 14. The indicia 16 are preferably reverse printed on the inner surface 17 of the outer layer 14. Flexographic printing is the preferred printing process, but other known methods, such as rotogravure printed may be acceptable.

Next, a layer of release coating 18 is applied in a pattern on a portion of the inner surface 17 of the outer layer 14 and over a portion of the indicia 16. The release coating 18 is preferably a release varnish or release lacquer, such as the Flexcon release lacquer RMW94546 by Flint Ink Corp. A primer may be applied between any layers as necessary to avoid adhesion failures for certain substrates, but a suitable ink for the indicia 16 may serve the same function as a primer.

The integrated coupon 12 is formed by slits 20 and 22 through the outer layer 14, the indicia 16, and into the layer of release coating 18, wherein the slits 20 and 22 are in alignment with the pattern of the layer of release coating 18. The controlled penetration of slits 20 and 22 does not go though all layers of the film 10, but preferably the slits 20 and 22 go completely through the layer of release coating 18. Preferably, slits 20 and 22 include perforations with intact portions of film 10 between each slit.

A second polymeric layer 24 is bonded to the outer layer 14 on the inner surface 17 having the indicia 16 and release coating 18. Preferably, the second polymeric layer 24 is an extrudate of polyethylene.

The second polymeric layer 24 may or may not be strong enough so additional layers may ensure there will be no compromise of the barrier characteristics of the film 10. Additional layers can be added, such as an inner layer 26 that is continuous to maintain barrier integrity or other properties. As an example, the inner layer 26 can be a metallized oriented polypropylene. Ideally, the layer under the peelable coupon 12 has a different appearance so it is apparent to a consumer when the peelable coupon 12 has been removed. This may result from the discontinuity of ink when a portion of the indicia 16 is removed with the peelable coupon 12. Other methods may result in the outer surface 28 appearing distinct from layer under the peelable coupon 12. For example, the second polymeric layer 24 or other inner layers 26 (if the second polymeric layer 24 is translucent or clear) can have a different appearance from an outer surface 28 of the outer layer 14. The film 10 can be printed on both the outer surface 28 and inner surface 17 of the coupon 12.

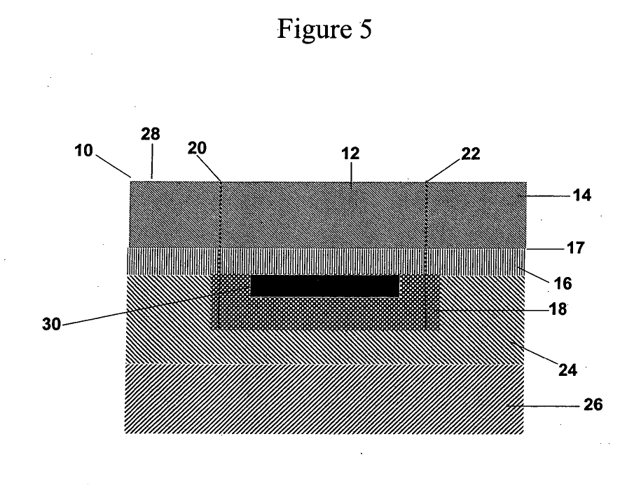

FIG. 5 shows a multilayer film 10 with a peelable coupon 12. Indicia 16 can be coated on an inner surface 17 of the outer layer 14. Another pattern of ink 30 is shown as printed on the indicia 16. Pattern of ink 30 may be ink jet printed to reflect a unique code on a web of continuous film used to produce numerous bags or packaging units. Indicia 16 can be opaque and continuous under the pattern of ink 30 so that pattern of ink 30 cannot be viewed through the outer layer 14.

Packaging film is typically produced on a web with repeating patterns that form each bag or packaging unit. The patterns can be made in the machine direction, but also across the film 10. Several repeating patterns can go across the web that can be cut into narrower films approximating the circumference of a packaging unit to be produced. As an example, the release coating 18 can be printed in a pattern on a surface of the outer layer 14 to form a 2.25 inch strip in the machine direction for each pattern across the web.

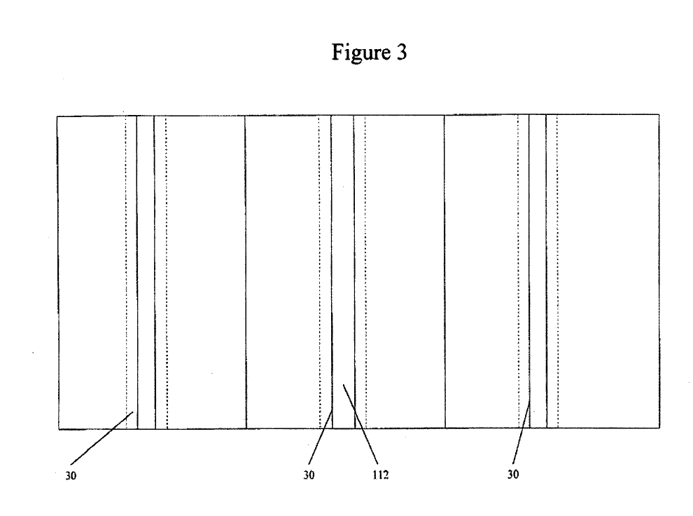

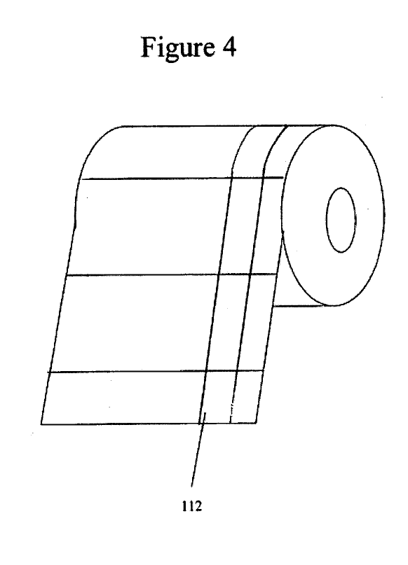

As shown in the particular embodiment of FIG. 3, three repeating patterns extend across the multilayer film 10 that forms a web with each pattern suitable for being cut into separate rolls for forming bags on processing machinery. The film 10 can be cut into individual rolls, as shown in FIG. 4, and then folded and sealed to form a bag. The slits (20 and 22) extend across an entire surface of the film 10 and the slits (20 and 22) are parallel to edges of the stripe of the layer of release coating 18. Each pattern can be formed with an integrated removable banner 112 that extends the entire length of the film 10.

For this example, three layers of release coating 18 are applied in stripes on a portion of the inner surface 17 of the outer layer 14. Each pattern of the film 10, although repeating, need not be exactly the same. Each pattern can have different indicia 16 or pattern of ink 30 on each portion of the inner surface 17 of the outer layer 14 that is between the slits (20 and 22). For this example, three sets of redeemable store coupons or games pieces could be printed for each row of peelable coupon 12 without changing the printing in the machine direction. In their final form, it is contemplated that the banners 112 could be delaminated from a packaging unit formed of the film 10 by peeling a corner of the coupon 12 at either the top or bottom of the banner 112. If the layer underneath the banner 112 has a different appearance than the outer surface 28, it will be readily apparent to the consumer whether the banner 112 has been removed. Also, each banner 112 of the three patterns could have different indicium.

A multilayer film 10 with an integrated coupon 12 may be manufactured using the steps of: (1) providing a first layer as an outer layer 14, (2) applying indicia 16 on an inner surface 17 of the outer layer 14, such as by reverse printing, (3) applying a layer of release coating 18 in a pattern to a portion of an inner surface 17 of the outer layer 14, (4) cutting slits 20 and 22 through the outer layer 14, the indicia 16, and into (preferably through) the layer of release coating 18, preferably in alignment with the pattern of the layer of release coating 18, and (5) extrusion laminating a second polymeric layer 24 to the outer layer 14 having the indicia 16 with the layer of release coating 18. The slits 20 and 22 are preferably cut as part of the lamination process. The cutting or scoring can be performed with a mechanical or laser cutting tool to define the peelable coupon. In a preferred method, two parallel slits 20 and 22 are cut the entire length of the film 10 so the second polymeric layer 24 forms the base for a removable banner 112, which is defined by the slits 20 and 22 in a line through the outer layer 14, the indicia 16, and into (preferably through) the layer of release coating 18. The slits 20 and 22 can be cut across a web or in the machine direction, but optional continuous cutting in the machine direction allows the mechanical or laser cutting tool to be continuously applied to the web.

Various additional types of printing can be used to enhance the desired features. The method may include step of printing unique codes for each repeating pattern on either surface of the removable coupon 12. As such, different game pieces or amounts of savings could be produced on or in the film 10. Numerous and different indicia 16 can be printed on a single web of film 10, including different indicia 16 under each banner 112.

The method may also have the additional step of printing on an outer surface 28 of the outer layer 14. The printing on the outer surface 28 of a portion of the outer layer 14 encompassing the integrated coupon 12 can have a printed entitlement, such as a cash refund, or other information. Also, lines 30 may be printed as a guide cutting slits 20 and 22 during manufacture or as border for the coupon 12 for the customer to peel or remove. The indicia 16 may be printed in repeating patterns for each packaging unit, such as a bag, that may be formed from the multilayer film 10.

Although preferred embodiments of the disclosure are illustrated and described in connection with particular features, it can be adapted for use with a wide variety of films and packaging. Other embodiments and equivalents of the film and removable coupon and related methods of making the films are envisioned within the scope of the claims. Various features of the disclosure have been particularly shown and described in connection with illustrated embodiments. However, it must be understood that the particular examples merely illustrate and that the invention is to be given its fullest interpretation within the terms of the claims.

What is claimed is:

1. A multilayer film with a peelable coupon comprising:
an outer polymeric layer,
indicia on an inner surface of the outer layer;
a layer of release coating in a pattern on a portion of the inner surface of the outer layer having the indicia,
the peelable coupon formed by slits through the outer layer, the indicia, and into the layer of release coating, wherein the slits are in alignment with the pattern of the layer of release coating, and
a second polymeric layer bonded to the outer layer.

2. The film of claim 1 wherein the release coating is selected from a group consisting of a release varnish and a release lacquer.

3. The film of claim 1 wherein the outer layer is oriented polypropylene.

4. The film of claim 1 wherein the second polymeric layer is an extrudate of polyethylene.

5. The film of claim 1 further comprising printing on an outer surface of a portion of the outer layer encompassing the peelable coupon.

6. The film of claim 1 further comprising an inner layer.

7. The film of claim 6 wherein the inner layer is continuous to maintain barrier integrity.

8. The film of claim 7 wherein the inner layer is metallized oriented polypropylene.

9. The film of claim 1 wherein the second polymeric layer has a different appearance from an outer surface of the outer layer so the removal of the peelable coupon with a section of indicia is apparent.

10. A multilayer film with an integrated removable banner suitable for forming a packaging unit, the film forming a web with repeating patterns, each pattern of the film comprising:
an outer layer,
indicia on an inner surface of the outer layer;
a layer of release coating in a stripe on a portion of the inner surface of the outer layer having the indicia, and
a second layer extrudate,
wherein the integrated removable banner is formed by slits through the outer layer, the indicia, and through the layer of release coating, wherein the slits extend across an entire surface of the film and the slits are parallel to edges of the stripe of the layer of release coating.

11. The multilayer film of claim 10, wherein each pattern has different indicia on each portion of the inner surface of the outer layer that is between the slits.

12. The film of claim 10 wherein the release coating is selected from a group consisting of a release varnish or a release lacquer.

13. The film of claim 10 wherein the outer layer is oriented polypropylene.

14. The film of claim 10 wherein the second polymeric layer is an extrudate of polyethylene.

15. The film of claim 10 further comprising printing on an outer surface of a portion of the outer layer encompassing the banner.

16. The film of claim 10 further comprising an inner layer that has a different appearance from an outer surface of the outer layer so it is apparent when the removable banner has been removed.

17. A method of manufacturing a multilayer film with an integrated coupon comprising the steps of:
providing a first polymeric layer as an outer layer,
reverse printing indicia on an inner surface of the outer layer,
applying a layer of release coating in a pattern to a portion of an inner surface of the first polymeric layer,
cutting slits through the outer layer, the indicia, and into the layer of release coating, and
extrusion laminating a second polymeric layer to the outer layer having the indicia with the layer of release coating.

18. The method of claim 17 wherein the step of cutting slits is in alignment with the pattern of the layer of release coating.

19. The method of claim 17 wherein the second polymeric layer is polyethylene.

20. The method of claim 17 wherein two parallel slit lines are cut an entire length of the film so the second polymeric layer has a removable banner strip defined by slit lines through the outer layer, the indicia, and into the layer of release coating.

21. The method of claim 20 comprising an additional step of printing on an outer surface of the first polymeric layer.

22. The method of claim 20 wherein the step of printing the indicia includes repeating patterns for each package that may be formed from the multilayer film.

23. The method of claim 22 comprising an additional step of printing unique codes for each repeating pattern on a surface of the removable banner strip.

24. The method of claim 17 wherein the release coating is a release lacquer.

25. The method of claim 17 wherein the release coating is a release varnish.

26. The method of claim 22 comprising an additional step of printing lines as a guide for cutting slits.

27. The method of claim 20 comprising an additional step of adding an additional inner layer to the multilayer film.

28. The method of claim 17 wherein the second polymeric layer has a different appearance from an outer surface of the outer layer when the integrated coupon has been removed due to the discontinuity of indicia when a portion of the indicia is removed with the integrated coupon.

29. The method of claim 17 wherein the step of cutting slits is performed before extrusion laminating.

30. The method of claim 17 wherein the step of extrusion laminating is performed before cutting slits.

31. The method of claim 17 wherein the step of cutting slits includes cutting through the layer of release coating.
